(19) United States
(12) Patent Application Publication
(10) Pub. No.: US 2019/0143905 A1
(43) Pub. Date: May 16, 2019

(54) IMAGE CAPTURE WITH A VEHICLE OBJECT SENSOR DEVICE BASED ON USER INPUT

(71) Applicant: Toyota Research Institute, Inc., Los Altos, CA (US)

(72) Inventor: James Cazzoli, Mahopac, NY (US)

(21) Appl. No.: 15/813,292

(22) Filed: Nov. 15, 2017

(51) Int. Cl. B60R 11/04; G06F 3/01; G02B 27/01

(52) U.S. Cl. CPC B60R 11/04; G06F 3/016; G02B 27/01; B60K 2350/2095; B60R 2300/802; G02B 2027/0138; B60K 2350/1028; B60R 2300/105

(57) ABSTRACT

A device and method for image capture are disclosed, in which user input data may be received via a vehicle-based graphical user interface (GUI) device. Responsive to subsequent user input data, the image data output of a vehicle object sensor device may be captured to produce captured image data, and streamed and/or transmitted for display by a display device based on the user input.

### FIELD

The subject matter described herein relates in general to image capture using vehicle object sensor devices and, more particularly, to a graphical user interface operable to select at least one of a plurality of vehicle object sensor devices for image capture based on vehicle occupant input.

### BACKGROUND

A vehicle can include a number of passenger windows, which may provide a graphical user interface to provide a virtual computer interface to the user. In this respect, a user may play games, watch media content, interact with others, etc. Generally, however, such interfaces have not provided a capability for a passenger to capture images relating to the environment outside the vehicle. Generally, such content needs to be captured with a handheld mobile device, such as a smartphone, or single purpose device such as a digital camera. A need exists for alternate image capture devices relating to on-board vehicle devices.

### SUMMARY

A device and method for image capture with a vehicle object sensor device based on user input are disclosed.

In one implementation, a method for image capture is disclosed. The method includes receiving user input data via a vehicle-based graphical user interface (GUI) device. Responsive to subsequent user input data, the method includes capturing image data output by the vehicle object sensor device to produce captured image data, and streaming and/or transmitting captured image data for display by a display device based on the user input.

In another implementation, an image capture device includes a communication interface to service communication with a vehicle network and a plurality of vehicle object sensor devices, a processor communicably coupled to the communication interface, and memory communicably coupled to the processor. The memory stores a vehicle-based graphical user interface module and an image data capture module. The vehicle-based graphical user interface module includes instructions that, when executed by the processor, cause the processor to receive user input data from a vehicle-based graphical user interface device, and based on the user input data, generate a identifier data for the vehicle object sensor device of the plurality of vehicle object sensor devices. The image data capture module including instructions that, when executed by the processor, cause the processor to, responsive to subsequent user input data, capture image data output by the vehicle object sensor device based on the identifier data to produce captured image data, and produce a data stream from the captured image data for display by a display device based on the subsequent user input via the vehicle network.

### BRIEF DESCRIPTION OF THE DRAWINGS

The description makes reference to the accompanying drawings wherein like reference numerals refer to like parts throughout the several views, and wherein:

FIG. 1 is a schematic illustration of a vehicle including an image capture device;

FIG. 2 illustrates partial interior view of the vehicle of FIG. 1 with a vehicle display device;

FIG. 3 illustrates a graphical user interface of the vehicle-based graphical user interface device of FIG. 2;

FIG. 4 is a block diagram of the image capture device of FIG. 1;

FIG. 5 illustrates a functional block diagram of an image capture device of FIG. 1; and

FIG. 6 shows an example process for image capture with a vehicle object sensor device based on user input.

### DETAILED DESCRIPTION

Image capture through one or more of a plurality of vehicle object sensor devices, and subsequent display is described herein.

One example method may be based on user input for a vehicle that one or more of a vehicle's displays, such as the vehicle windows, can be configured to provide a user interface to a user to capture photographs/videos of the external environment with the vehicle camera sensors.

The vehicle can be equipped with one or more sensor input devices, such as (visible and/or invisible light cameras) cameras, LiDAR sensor devices, radar sensor devices, etc. The sensor input devices can be configured to acquire image data of a portion of the surrounding environment of a vehicle. One or more sensor input devices can be positioned to capture image data in a portion of the external environment that substantially corresponds to what a passenger can view through one of the windows. Also, the vehicle can be configured to track a user's head and/or eye position (using any suitable technology) to more accurately capture images/videos from the user's perspective. Based on this tracking, an appropriate vehicle camera may be selected for image capture.

An icon or other graphical user interface (GUI) element (such as a camera icon, video icon, image characteristic icons, etc.) can be presented to the user via the display surface for image capture. An icon can be unobtrusive so as not to interfere with the user's view of the external environment (such as being located in or near one of the corners of the window). The user interface can be used/activated if a user selects (e.g., taps) an icon on the window.

In operation, when selected by a user, captured data image (such as a photograph or video) of the external environment can be automatically captured. Also, a plurality of image options can be presented to the user for capturing a desired photo/video, such as (a) an image capture bounding frame can be presented on the window, thereby showing the user the boundaries of the photo/video that will be taken, (b) may be able to modify the frame, (c) select/modify the image viewing angle, (d) select vehicle camera sensor for image capture, and/or (e) other photos/video capture options or effects (such as, filters, zoom, flash/no flash, etc.).

The captured image data may be displayed to a window of the vehicle specified by the user, and/or may be emailed or texted to the user at a user designated phone number and/or address. The sending can be done automatically, based on the user preferences, or the user can input information as to the recipient(s) of the picture/video (such as explanatory notes, person's names, etc.). The user may input such information using the interface on the window, as well as tag captured image data so that the vehicle user can create structured data in the surrounding world.

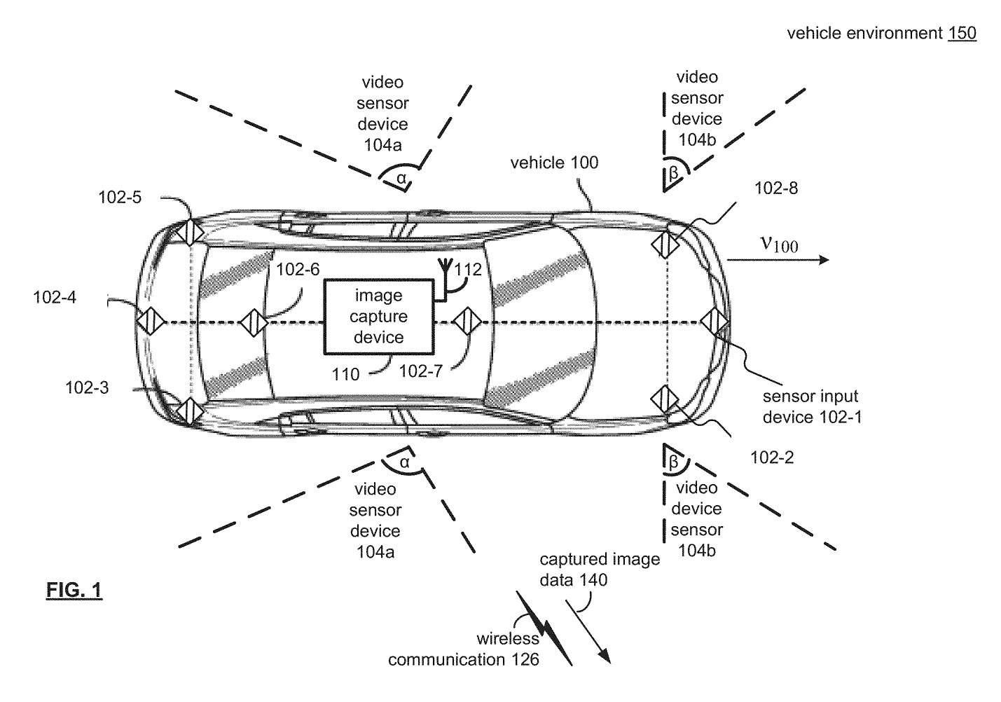

FIG. 1 is a schematic illustration of a vehicle 100 including an image capture device 110 having an antenna 112. A plurality of object sensor devices 102 and are in communication with the image capture device 110 to access a vehicle environment 150. As may be appreciated, the vehicle 100 may also be an automobile, light truck, cargo transport, or any other passenger or non-passenger vehicle.

The plurality of object sensor devices 102 and/or 104 may be positioned on the outer surface of the vehicle 100. Moreover, the sensor input devices may operate at frequencies in which the vehicle body or portions thereof appear transparent to the respective sensor device.

Communication between the sensor input devices and vehicle control units, including image capture device 110, may be on a bus basis, and may also be used or operated by other systems of the vehicle 100. For example, the object sensor devices 102 and/or 104 may be coupled by a combination of network architectures such as a Body Electronic Area Network (BEAN), a Controller Area Network (CAN) bus configuration, an Audio Visual Communication-Local Area Network (AVC-LAN) configuration, and/or other combinations of additional communication-system architectures to provide communications between devices and systems of the vehicle 100.

The object sensor devices may include sensor input devices 102-1, 102-2, 102-3, 102-4, 102-5, 102-6, 102-7 and 102-8, and video sensor devices 104a and 104b on the driver side and passenger side of the vehicle 100. The outputs of the example sensor input devices 102 and/or 104 may be used by the image capture device 110 via a user interface provided by a vehicle display surface.

As may be appreciated, when not selectively used by a vehicle passenger for image capture via the image capture device 110, the object sensor devices may operate to detect vehicular transition events for vehicle operation

The sensor input devices 102, by way of example, may operate to sense tactile or relational changes in the vehicle environment 150, such as an approaching pedestrian, cyclist, object, vehicle, road debris, etc. A vehicle occupant may also be able to capture images through the sensor input devices 102 and/or 104. Based on the user input data to the image capture device 110, a user may identify a vehicle object sensor device from the sensor input devices 102-1 through 102-8, and/or video sensor devices 104a via the vehicle-based graphical user interface device.

Responsive to subsequent user input data, such as a capture command, the image capture device 110 may operate to capture image data output by the vehicle object sensor device selected by the user to produce captured image data. The captured image data 140, which may be a still image in a preferred format for the user (such as JPEG, PNG, PDF, etc.) and/or in a streaming format (such as MP4, FLV, WebM, ASF, ISMA, etc.). Based on user input, image and/or streaming formats of the captured image(s) may be streamed, via a vehicle network, for display on a display device of the vehicle and/or via the wireless communication 126 via the antenna 112 for display through a handheld mobile device, such as a smartphone, a tablet, a phablet, a laptop computer, etc.

The sensor input devices 102-1 through 102-8 may be provided by a Light Detection and Ranging (LIDAR) system, in which the sensor input devices 102-1 through 102-8 may capture data related to laser light returns from physical objects in the environment of the vehicle 100. The sensory input devices 102-1 through 102-8 may also include a combination of lasers (LIDAR) and milliwave radar devices. For providing meaningful image capture to a user, the data captured by the sensor input devices 102-1 through 102-8 may be augmented, filtered, enhanced, etc. based on the preference of the user.

The video sensor device 106a may have a three-dimensional field-of-view of angle-α, and the video sensor device 106b may have a three-dimensional field-of-view of angle-β, with each video sensor having a sensor range for video detection.

In the various driving modes, the examples of the placement of the video sensor devices 106a for blind-spot visual sensing (such as for another vehicle adjacent the vehicle 100) relative to the vehicle user, and the video sensor devices 106b are positioned for forward periphery visual sensing (such as for objects outside the forward view of a vehicle user, such as a pedestrian, cyclist, vehicle, road debris, etc.).

For adjusting data input from the sensors 102 and/or 104, the respective sensitivity and focus of each of the sensor devices may be adjusted to limit data acquisition based upon speed, terrain, activity density around the vehicle, etc., via a vehicle control unit, or via the image capture device 110 based on user input.

For example, though the field-of-view angles of the video sensor devices 106a and 106b may be in a fixed relation to the vehicle 100, the field-of-view angles may be adaptively increased and/or decreased based upon a vehicle driving mode. For example, a highway driving mode may cause the sensor devices less of the ambient conditions in view of the more rapidly changing conditions relative to the vehicle 100, while a residential driving mode to take in more of the ambient conditions that may change rapidly (such as a pedestrian that may intercept a vehicle stop range by crossing in front of the vehicle 100, etc.).

The sensor devices 102 and/or 106 may, alone or in combination, operate to capture field-of-depth images or otherwise generating depth information for a captured image. For example, the devices 102 and/or 104 may configured to capture images in visual and/or non-visual spectrum wavelengths, which may be pre-filtered digitally, rendered and/or enhanced for visual display to a user.

In this aspect, the object sensor devices 102 and 104 can be operable to determine distance vector measurements of objects in the environment of vehicle 100. For example, the sensor devices 102, 104 and 106 depth camera 128 may be configured to sense and/or analyze structured light, time of flight (e.g., of signals for Doppler sensing), light detection and ranging (LIDAR), light fields, and other information to determine depth/distance and direction of objects.

The object sensor devices 102 and 104 may capture color images. For example, a depth camera for a video sensor device 104a and/or 104b may have a RGB-D (red-green-blue-depth) sensor(s) or similar imaging sensor(s) that may capture images including four channels—three color channels and a depth channel.

Alternatively, in some embodiments, the image capture device 110 may be operable to designate object sensor devices 102 and 104 and with different and/or complementary imaging data functions. For example, via user input, the image capture device 110 may designate one set of sensor devices for color imagery capture, designate another set of sensor devices to capture object distance vector data for depth-of-field enhancement and/or focus, and designate (or re-purpose) yet another set of sensor devices to determine specific object characteristics, such as pedestrian identity.

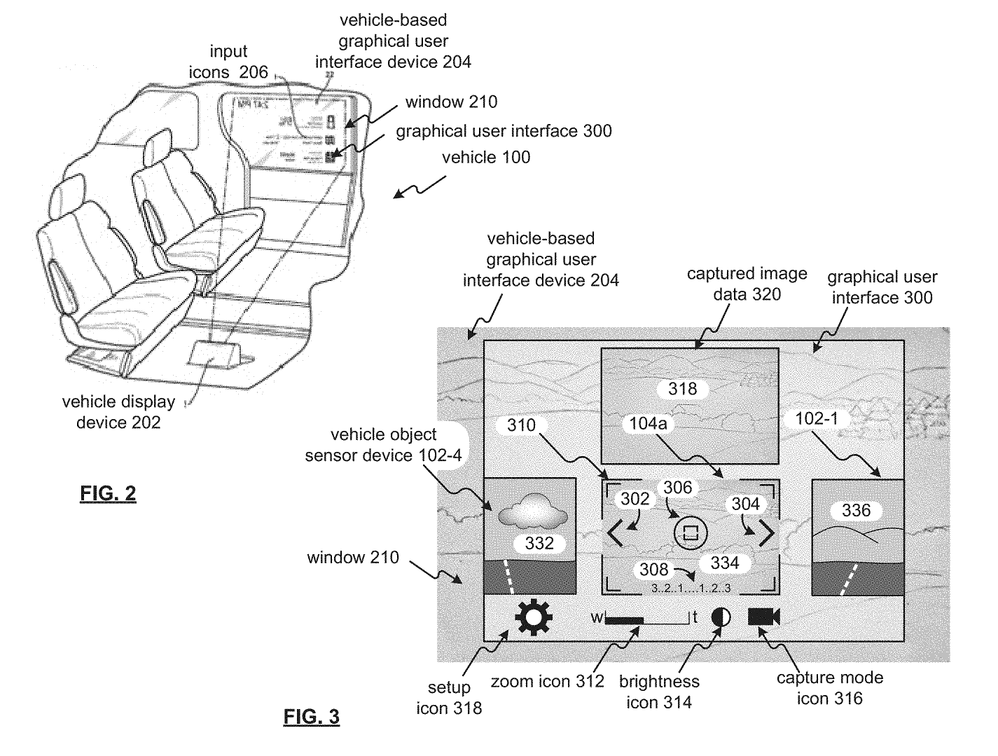

As may be appreciated, multiple display devices may be positioned in the vehicle and vehicle surfaces, such as along passenger windows, or surfaces designated for display devices, such as a head unit. User input may include tactile instructions via a graphical user interface, and/or gesture tracking of a user, such as through gaze tracking, motion recognition, and/or gestures. Aspects underlying vehicle-to-human communications and/or dialogues are discussed in detail with reference to FIGS. 2-6.

FIG. 2 illustrates partial interior view of a vehicle 100 with a vehicle display device 202. The display device 202 may include a device, or devices, capable of displaying a vehicle-based graphical user interface device 204 including input icons 206 to receive user input. The graphical user interface device 204 may provide a tactile display presented by a vehicle window surface for receiving user input.

As may be appreciated, the image displayed on the vehicle surface, such as the vehicle window, may be configured to be viewed from outside the vehicle 100, inside the vehicle 100, or both. The vehicle display device 202 may also be provided via a heads-up display device, a head unit display device, a rear-seat console display device, etc.

An example the vehicle display device 202, coupled with the image capture device 110 (FIG. 1), may include a display device integral to the window 210, such as an LCD film, and OLED display, a polymer dispersed liquid crystal (PDLC) film, in which such displays may provide both transparency when inactive and partial or complete opacity when active.

As will be further described, the graphical user interface 300 may include can include personalized information or entertainment content such as videos, games, maps, navigation, vehicle diagnostics, calendar information, weather information, vehicle climate controls, vehicle entertainment controls, email, internet browsing, or any other interactive applications associated with the recognized user, whether the information originates onboard and/or off board the vehicle 100, as discussed in detail with reference to FIG. 3.

FIG. 3 illustrates a graphical user interface 300 of the vehicle-based graphical user interface device 204 of FIG. 2. The graphical user interface 300 may include panes 318, 332, 334 and 336. The panes 332, 334 and 336 may be associated with a vehicle sensor input device such as device 102-4 having a rearward orientation, 104a having a sideward orientation, and 102-1 having a frontward orientation. The additional panes may relate to other vehicle sensor input devices of the vehicle 100, as shown in FIG. 1.

With the example of FIG. 3, a user may identify a vehicle object sensor device of the plurality of vehicle object sensor devices via the selection icons 302 and 304. For example, the selection icon 302 receives tactile user input to scroll left through the device panes, while selection icon 304 receives tactile user input to scroll right through the device panes. A pane selection may be made by discontinuing scrolling through the available panes of the graphical user interface 300.

For example, the selected pane 334, which relates to the vehicle object sensor device 104a, may generally correlate with the user seated in the passenger seat while looking out a window 210. Accordingly, the graphical user interface 300 provides an overlay, allowing the user to view the present view through the window 210, while also viewing the pane contents for selection.

Pane 334, which has been identified via user input, such as tactile input, gaze tracking, gesture tracking, etc., may include icons to further manipulate the image as depicted via the pane 334. For example, a user may adjust image exposure through an exposure icon 308, zoom-in or zoom-out on the image via the zoom icon 312, adjust a brightness of the image via the brightness icon 314, and toggle from a video capture of the image, based on a series of captured images, or a still captured image of the view by the identified vehicle object sensor device.

Upon providing a subsequent user input by selecting the capture icon 306, a capture command may be received by the image capture device 110, which may store the captured image data, and may format the captured image data for display by the vehicle display device 202. The identified and/or “live” pane 334 may be also provide a user a plurality of sequential images for selection.

The captured image data 320 may be presented for display to the user via display pane 318 of the vehicle-based graphical user interface 300. The devices 102 and/or 104 may configured, via the user input, to capture images in, for example, visual and/or non-visual spectrum wavelengths, that may be digitally pre-filtered, rendered and/or enhanced for visual display to a user via the identified pane 334, and captured by the user for display to the display pane 318.

A user may also select a setup icon to enter preferences with capturing image data. For example, panels may be assigned to one or all of the vehicle object sensor devices 102 and/or 104, and arranged in a predetermined presentation order to the user via the selection icons 302 and 304. Also, digital pre-filtering, rendering and/or enhancements may be selected for each of the devices 102 and/or 104.

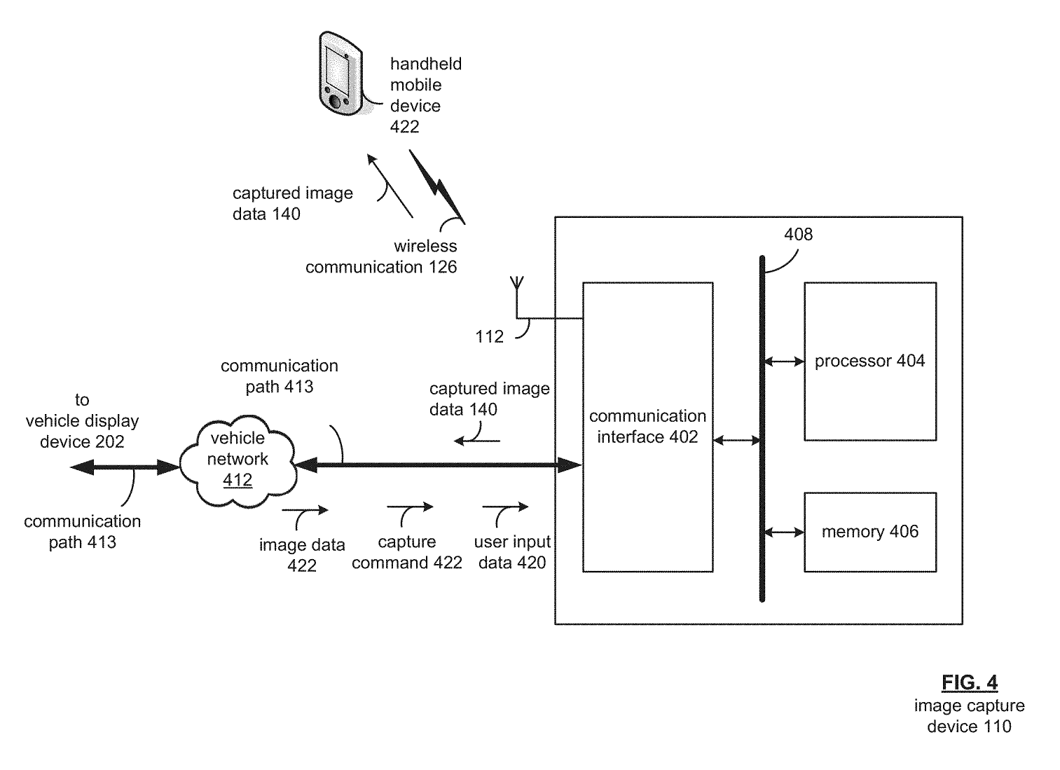

FIG. 4 is a block diagram of an image capture device 110, which includes a wireless communication interface 402, a processor 404, and memory 406, that are communicatively coupled via a bus 408.

The processor 404 of the image capture device 110 can be a conventional central processing unit or any other type of device, or multiple devices, capable of manipulating or processing information. As may be appreciated, processor 404 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

The memory and/or memory element 406 may be a single memory device, a plurality of memory devices, and/or embedded circuitry of the processor 404. Such a memory device may be a read-only memory, random access memory, volatile memory, non-volatile memory, static memory, dynamic memory, flash memory, cache memory, and/or any device that stores digital information. Furthermore, arrangements described herein may take the form of a computer program product embodied in one or more computer-readable media having computer-readable program code embodied, e.g., stored, thereon.

Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. In the context of this document, a computer-readable storage medium may be any tangible medium that can contain, or store a program for use by or in connection with an instruction execution system, apparatus, or device.

The memory 406 is capable of storing machine readable instructions, or instructions, such that the machine readable instructions can be accessed by the processor 404. The machine readable instructions can comprise logic or algorithm(s) written in programming languages, and generations thereof, (e.g., 1GL, 2GL, 3GL, 4GL, or 5GL) such as, for example, machine language that may be directly executed by the processor 404, or assembly language, object-oriented programming (OOP), scripting languages, microcode, etc., that may be compiled or assembled into machine readable instructions and stored on the memory 406. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods and devices described herein may be implemented in any conventional computer programming language, as pre-programmed hardware elements, or as a combination of hardware and software components.

Note that when the processor 404 may include more than one processing device, the processing devices may be centrally located (e.g., directly coupled together via a wired and/or wireless bus structure) or may be distributed located (e.g., cloud computing via indirect coupling via a local area network and/or a wide area network). Further note that when the processor 404 implements one or more of its functions via a state machine, analog circuitry, digital circuitry, and/or logic circuitry, the memory and/or memory element storing the corresponding operational instructions may be embedded within, or external to, the circuitry including the state machine, analog circuitry, digital circuitry, and/or logic circuitry.

Still further note that, the memory 406 stores, and the processor 404 executes, hard coded and/or operational instructions corresponding to at least some of the steps and/or functions illustrated in FIGS. 1-6. The image capture device 110 is operable to receive, via the wireless communication interface 402 and communication path 413, user input data 420, also a capture command 422, and image data 422, and to produce captured image data 140.

In operation, the image capture device 110 may operate to provide an image capture capability with sensor devices generally affiliated with autonomous and/or safety features for vehicles. When a user provides user input data 420, the user may effectively monitor the point of view of each of the sensor devices 102 and/or 104, while each of the devices may continue to be implemented for the primary function of autonomous operation and/or vehicle safety features.

When receiving a capture command 422 via a subsequent user input data input, the image capture device 100 may operate to produce the captured image data 140, which may be stored according to the capture command (such as a buffer defined in the memory 406, which may be related to the display pane 318 of FIG. 3, or a buffer associated with the wireless communication 126). The captured image data 140 may be formatted for display by a vehicle display device 202, or to a handheld mobile device 422 accessible via the wireless communication 126, and stream the captured image data for display to the vehicle display device 202, to other vehicle displays, or to a handheld mobile device 422 via the wireless communication 126. The handheld mobile device 422 may include a smartphone, a cell phone, a tablet computer, a phablet computer, a laptop, etc.

The vehicle 100 may include one or more modules, at least some of which are described herein. The modules can be implemented as computer-readable program code that, when executed by a processor 404, implement one or more of the various processes described herein. One or more of the modules can be a component of the processor(s) 404, or one or more of the modules can be executed on and/or distributed among other processing systems to which the processor(s) 404 is operatively connected. The modules can include instructions (e.g., program logic) executable by one or more processor(s) 404.

The communications interface 402 generally governs and manages the data received via a vehicle network and/or the wireless communication 126. There is no restriction on the present disclosure operating on any particular hardware arrangement and therefore the basic features herein may be substituted, removed, added to, or otherwise modified for improved hardware and/or firmware arrangements as they may develop.

The antenna 112, with the wireless communications interface 302, operates to provide wireless communications with the image capture device 110, including wireless communication 126.

Such wireless communications may range from national and/or international cellular telephone systems to the Internet to point-to-point in-home wireless networks to radio frequency identification (RFID) systems. Each type of communication system is constructed, and hence operates, in accordance with one or more communication standards. For instance, wireless communication systems may operate in accordance with one or more standards including, but not limited to, 3GPP (3rd Generation Partnership Project), 4GPP (4th Generation Partnership Project), 5GPP (5th Generation Partnership Project), LTE (long term evolution), LTE Advanced, RFID, IEEE 802.11, Bluetooth, AMPS (advanced mobile phone services), digital AMPS, GSM (global system for mobile communications), CDMA (code division multiple access), LMDS (local multi-point distribution systems), MMDS (multi-channel-multi-point distribution systems), and/or variations thereof.

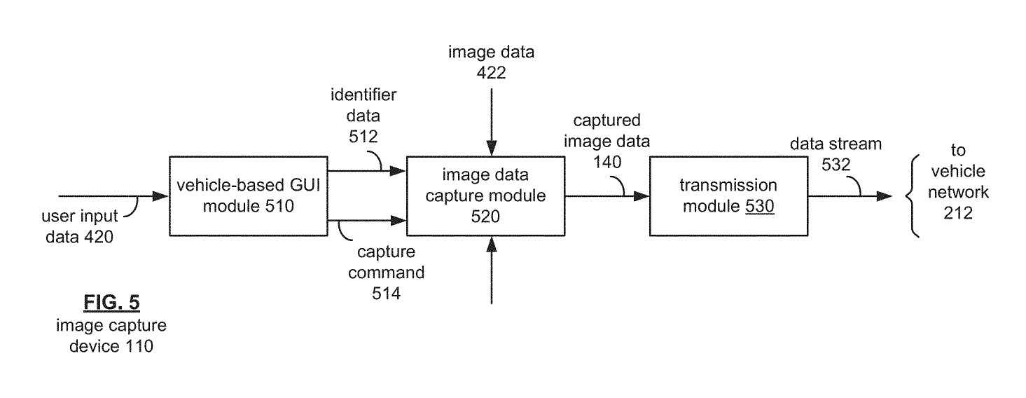

FIG. 5 illustrates a functional block diagram of an image capture device 110. The image capture device 110 may include a vehicle-based graphical user interface (GUI) module 510, an image data capture module 520, and transmission module 530.

The vehicle-based graphical user interface module 510 includes instructions that, when executed by the processor 404, cause the processor 404 to receive user input data from a vehicle-based graphical user interface device, and based on the user input data, generate identifier data for the vehicle object sensor device of the plurality of vehicle object sensor devices.

In this respect, the vehicle occupant may be able to capture images through at least one sensor input devices of a vehicle. Based on the user input data 420 to the image capture device 110, a user may identify a vehicle object sensor device from the sensor input devices 102-1 through 102-8, and/or video sensor devices 104a via the vehicle-based graphical user interface device for image capture. Based on this user input 420, the vehicle-based GUI module 510 may operate to produce identifier data 512 relating to a vehicle object sensor device of a plurality of vehicle object sensor devices.

Responsive to subsequent user input data 420, such as a capture command, 514 the image capture device 110 may operate to capture image data output by the vehicle object sensor device selected by the user to produce captured image data.

The image data capture module 520 includes instructions that, when executed by the processor 404, cause the processor 404 to, in response to subsequent use input data in the form of a capture command 514, capture image data 422 output by the vehicle object sensor device based on the identifier data 512 to produce captured image data 140. Further instructions cause the processor 404 to produce a data stream from the captured image data via a transmission module 530 for display by a display device based on the user input via the vehicle network 212.

The captured image data 140, which may be a still image in a preferred format for the user (such as JPEG, PNG, PDF, etc.) and/or in a streaming format (such as MP4, FLV, WebM, ASF, ISMA, etc.). Based on user input, image and/or streaming formats of the captured image(s) may be streamed, via a vehicle network, for display on a display device of the vehicle and/or via the wireless communication 126 via the antenna 112 for display through a handheld mobile device, such as a smartphone, a tablet, a phablet, a laptop computer, etc.

The image data capture module 520 may include further instructions that cause the processor 404 to receive the capture command 514 relating to the image data 422. As may be appreciated, the identifier data 512 may operate a multiplexer relating to each of the data paths for each of the vehicle sensor input devices 102-1 to 102-8, and video sensor devices 104a and 104b (FIG. 1). Also, as the data paths may provide packet formats, the identifier data 512 may permit the image data capture module 520 to provide a routing function to select the respective data outputs of the devices to produce captured image data 140.

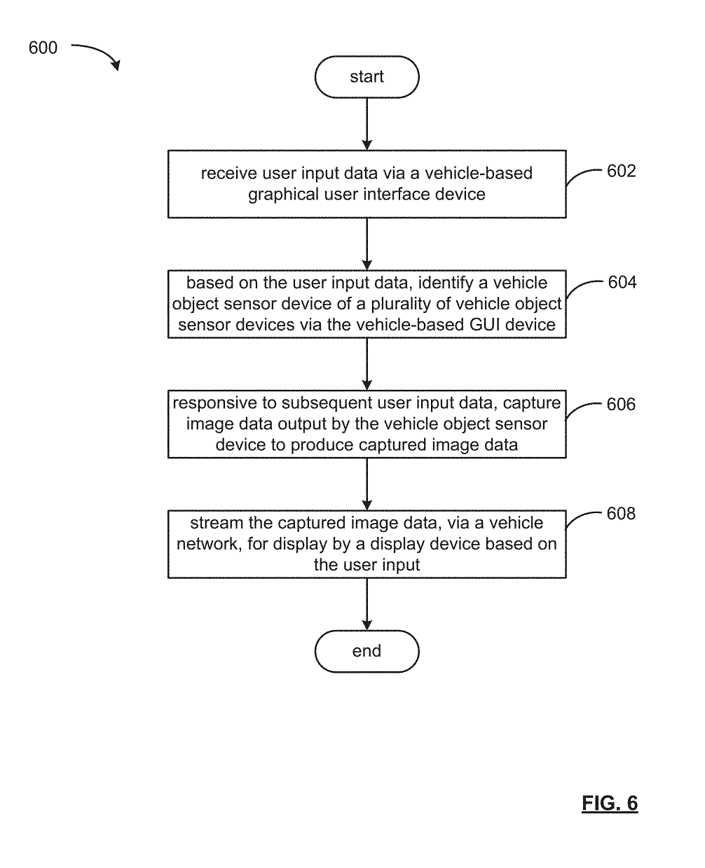

FIG. 6 shows an example process 600 for image capture with a vehicle sensor input device based-on user input. At operation 602, an image capture device receives user input data via a vehicle-based graphical user interface device. Based on the user input data, operation 604 identifies a vehicle object sensor device of a plurality of vehicle object sensor devices via the vehicle-based GUI device.

In other words, a user may identify a vehicle object sensor device of the plurality of vehicle object sensor devices through a user input. Examples of user input may be the selection of the vehicle object sensor device using selection icons 302 and 304 (FIG. 3). Such selection features may operate to permit a user to scroll left or right through panes presenting images representative of the data from a plurality of vehicle object sensor devices. Also, the user input may provided through a preference setting, in which a desired vehicle object sensor device may be pre-selected, while also permitting a user to scroll through the various data outputs of the devices.

In operation 606, responsive to subsequent user input data such as capture command, image data output by the vehicle object sensor device may be captured to produce captured image data. Operation 606 may further include capturing images in visual and/or non-visual spectrum wavelengths, which may be pre-filtered digitally, rendered and/or enhanced for visual display to a user.

In operation 608, the captured image data may be streamed and/or transmitted, via a vehicle network, for display by a display device based on the user input. For streaming and/or transmission, the captured image data may be a still image in a preferred format for the user (such as JPEG, PNG, PDF, etc.) and/or in a streaming format (such as MP4, FLV, WebM, ASF, ISMA, etc.). Moreover, the captured image data may be streamed and/or transmitted via a vehicle network, and/or via a wireless communication for display through a handheld mobile device, such as a smartphone, a tablet, a phablet, a laptop computer, etc.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

Various embodiments are shown in FIGS. 1-6, but the embodiments are not limited to the illustrated structure or application. As one of ordinary skill in the art may appreciate, the term “substantially” or “approximately,” as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items range from a difference of a few percent to magnitude differences.

As one of ordinary skill in the art may further appreciate, the term “coupled,” as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (that is, where one element is coupled to another element by inference) includes direct and indirect coupling between two elements in the same manner as “coupled.”

As the term “module” is used in the description of the drawings, a module includes a functional block that is implemented in hardware, software, and/or firmware that performs one or more functions such as the processing of an input signal to produce an output signal. As used herein, a module may contain submodules that themselves are modules.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The devices and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The devices and/or processes also can be embedded in a computer-readable storage medium, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method for image capture comprising:
receiving user input data via a vehicle-based graphical user interface device;
based on the user input data, identifying a vehicle object sensor device of a plurality of vehicle object sensor devices via the vehicle-based GUI device;
responsive to subsequent user input data, capturing image data output by the vehicle object sensor device to produce captured image data; and
streaming the captured image data, via a vehicle network, for display by a display device based on the user input.

2. The method of claim 1 wherein the capturing the image data output further comprising:
receiving a capture command via the subsequent user input data relating to the image data for producing the captured image data;
storing the captured image data corresponding to the capture command;
formatting the captured image data for display by the vehicle display device based on the user input; and
streaming the image data for display by the vehicle display device.

3. The method of claim 1, wherein the capture command further comprises a plurality of image capture parameters.

4. The method of claim 3, wherein the plurality of image capture parameters comprise at least two of:
a vehicle object sensor device source address;
a display device destination address;
a duration parameter;
a filter designation parameter;
a brightness parameter;
a hue parameter;
a gain parameter;
an exposure parameter; and
a contrast parameter.

5. The method of claim 1, wherein the vehicle-based graphical user device comprises a tactile display presented by a vehicle window surface.

6. The method of claim 1, wherein the vehicle-based graphical user interface device comprises a vehicle window surface operable to detect a tactile user input.

7. The method of claim 1, wherein the vehicle display device comprises at least one of:
a vehicle window surface of a plurality of vehicle window surfaces;
a heads-up display device; and
a head unit display device.

8. The method of claim 1, wherein the vehicle object sensor device comprises at least one of:
a LiDAR sensor device;
a camera sensor device;
an infrared camera sensor device; and
a RADAR sensor device.

9. A method for image capture comprising:
displaying, for user input, a graphical user interface including a plurality of vehicle object sensor devices;
receiving the user input via the graphical user interface;
based on the user input, identifying a vehicle object sensor device of the plurality of vehicle object sensor devices;
capturing image data output by the vehicle object sensor device; and
streaming the image data, via a vehicle network, for display by a vehicle display device based on the user input.

10. The method of claim 9, wherein the receiving the user input via the graphical user interface further comprises:
receiving a capture command relating to the image data;
storing the image data corresponding to the capture command; and
formatting the image data for display by the vehicle display device based on the user input.

11. The method of claim 9, wherein the graphical user interface is presentable via a display presented by a vehicle window surface.

12. The method of claim 9, wherein the vehicle window surface is configured to detect a tactile user input.

13. The method of claim 9, wherein the vehicle display device comprises at least one of:
a vehicle window surface of a plurality of vehicle window surfaces;
a heads-up display device; and
a head unit display device.

14. The method of claim 9, wherein the vehicle object sensor device comprises at least one of:
a LiDAR sensor device;
a camera sensor device;
an infrared camera sensor device; and
a RADAR sensor device.

15. An image capture device comprising:
a communication interface to service communication with a vehicle network and a plurality of vehicle object sensor devices;
a processor communicably coupled to the communication interface; and
memory communicably coupled to the processor and storing:
a vehicle-based graphical user interface module including instructions that, when executed by the processor, cause the processor to:
receive user input data from a vehicle-based graphical user interface device; and
based on the user input data, generate a identifier data for the vehicle object sensor device of the plurality of vehicle object sensor devices; and
an image data capture module including instructions that, when executed by the processor, cause the processor to:
responsive to subsequent user input data, capture image data output by the vehicle object sensor device based on the identifier data to produce captured image data; and
produce a data stream from the captured image data for display by a display device based on the subsequent user input via the vehicle network.

16. The image capture device of claim 15, wherein the image data capture module including further instructions that, when executed by the processor, cause the processor to
receive a capture command relating to the image data;
store the captured image data corresponding to the capture command;
format the captured image data for display by the vehicle display device based on the user input; and
transmit the captured image data for display by the vehicle display device.

17. The image capture device of claim 15, wherein the vehicle-based graphical user interface device comprises a tactile display presented by a vehicle window surface.

18. The image capture device of claim 15, wherein the vehicle-based graphical user interface device comprises a vehicle window surface operable to detect a tactile user input.

19. The image capture device of claim 15, wherein the vehicle display device comprises at least one of:
a vehicle window surface of a plurality of vehicle window surfaces;
a heads-up display device; and
a head unit display device.

20. The image capture device of claim 15, wherein the vehicle object sensor device comprises at least one of:
a LiDAR sensor device;
a camera sensor device;
an infrared camera sensor device; and
a RADAR sensor device.
